(19) United States
(12) Patent Application Publication
(10) Pub. No.: US 2022/0067829 A1
(43) Pub. Date: Mar. 3, 2022

(54) SYSTEM AND METHOD OF PROTECTING VALUE IN TWO ECONOMIC SYSTEMS

(71) Applicant: COLEEN ALTHEA MILLS, MONTGOMERY VILLAGE (US)

(72) Inventor: COLEEN ALTHEA MILLS, MONTGOMERY VILLAGE (US)

(21) Appl. No.: 17/521,583

(22) Filed: Nov. 8, 2021

Related U.S. Application Data
(63) Continuation-in-part of application No. 15/815,709, filed on Nov. 17, 2017.

(51) Int. Cl. G06Q 40/02

(52) U.S. Cl. CPC G06Q 40/025; G06Q 20/065

(57) ABSTRACT

A zero-coupon loan system and method can be used globally by a variety of borrowers for financial and economic development, stability, expansion, and revitalization by using a computer system to divide value borrowed from developed nations into value within the system of developed nations and developing nations to offset risks to value in the developing nations whereupon after employment of the values, the values are later combined into the system of the developed nations.

### CLAIM OF PRIORITY

This application claims the benefit of and priority to U.S. patent application No. Ser. No. 15/815,709 filed on Nov. 11, 2017, titled MILLS ZERO-COUPON LOAN, the contents of which are incorporated by reference in their entireties.

### FIELD OF THE INVENTION

The inventive concept relates generally to a system and method of protecting value in two economic systems.

### BACKGROUND

Developing economies (DE) and numerous entities have been borrowing money to fund infrastructure development, manufacturing, and various projects for economic growth and stability for years. However, the loans for these undertakings are usually from foreign, more industrialized nations in their respective hard currencies and the earnings to repay these loans are usually in the borrower's soft, domestic currencies. For example, Ethiopia borrows money from the United States (US) to build roads. Even if Ethiopia charges tolls on these roads and increases taxes to repay the loan, these revenues are in Ethiopian Birr (EBT). The loan still has to be repaid in foreign currency, US Dollar. This increase demand for hard currencies (from industrialized nations which are globally traded with expected stability) such as; the United States (US) Dollar, Japanese Yen, European Euro, German Mark and the British Pound Sterling, may also cause a relative devaluation of the local “soft” currencies in most developing nations. For example, if the loan was originated when the value of the DE's currency was US $1 equals EBT5 in year 1 and in year 2 of the loan the US$1 equals EBT10, it now cost two (2) times more EBT to repay the same amount of debt. This continuous relative devaluation and growing compounded interest makes it difficult for DEs to repay their debts owed to external sources. The world saw the “Latin American Debt Crisis” and defaults in the 1980's and 1990's and “Live Aide” for debt relief in the 2000's. Even today with the intervention of the World Bank and the International Monetary Fund, with loan restructuring in lieu of defaults and attempts to improve credit soundness with Basel I, II, and III, economies continue to see the amount of outstanding debt grow beyond most of the DE's ability to repay, and/or the austerity programs implemented appears to have slowed economic growth and development significantly for these borrowers. To date, many borrowers, especially poor ones, are given high interest rate loans that they have difficulty repaying. To avoid default, these loans may be rolled over into an increased loan amount with more fees, penalties, and perhaps even higher interest rates. This becomes a continuous negative cycle. Therefore, an improved solution is needed to allow developing nations to avoid currency valuation swings between currencies of developing nations and currencies of developed nations that may otherwise raise the cost of debt.

### SUMMARY OF THE INVENTION

The inventive concept includes a method of protecting value that involves dividing an asset of a first system that may be a financial asset such as a hard currency of a developed nation into a first portion of value that is still in the hard currency of the developed nation and a second portion of value that may be in the soft currency of a developing nation wherein the first portion of value is independent of the second portion of value by residing the first portion of value within the first system and the second portion of value into a second system that may be the developing nation. Calculating a net present value for the first portion of value that will offset a loss of the second portion of value through an investment in a vehicle with an agreed upon risk and reward profile. Monitoring performance of the first portion of value and the second portion of value and adjusting the values as needed. Then recombining the first portion of value and the second portion of value as an asset from a sum of the first portion of value and a second portion of value wherein both portions of value are again a part of the first system.

The inventive concept uses a system of protecting value in two economic systems that has at least one computer system adapted to divide an asset of a first system into a first portion of value and a second portion of value wherein the first portion of value is independent of the second portion of value by residing the first portion of value within the first system and the second portion of value into a second system. At least one memory device is designed to calculate from an algorithm the net present value for the first portion of value that will offset a loss from the second portion of value. The at least one computer system is designed to monitor the performance of the first portion of value and the second portion of value. The at least one computer system is designed to recombine the asset as a sum of the first portion of value and a second portion of value wherein both portions of value are a part of the first system.

The inventive concept breaks a cycle of requiring a borrower in a developing nation to borrow in currencies from developed nations and collect revenues to repay those loans in the currencies of developing nations that may be less stable. A borrower accesses a financial computer network via computer, phone, smartphone, or other input device to access the zero coupon loan application or download the Zero-Coupon loan application. The borrower completes the application to include the name, address, social security, EIN (if it is for a business), and purpose. In some embodiments where applicants lack a social security or EIN number, other identifying information compatible with the country of loan origination may be used.

Upon approval, a percentage of the loan proceeds is released to the borrower and the remainder is set aside and invested for repayment of the loan at or prior to maturity. The borrower then has several repayment options:
1. Repay the loan from personal or business revenue/earnings
2. Repay the loan with earnings from the invested funds
3. Repay with a combination of both
4. The borrower can let funds continue to grow and then pay off the loan before maturity as a lump sum.
   The loan is issued at or below market interest rate because of the increased possibility of repayment. The escrowed funds are invested at a higher rate of return than the interest rate of the loan. The system calculates the amount of funds that have to be set aside and invested in order for the loan to be repaid in full at or prior to maturity. This amount is based on risk assessment, loan (amount, term, interest rate), industry location, and performance in which the borrower operates or is employed, performance rate of the investment and other factors. Borrowers are able to log in at any time to review, pay loan, check investment performance, and interface.

There are many economically depressed communities around the globe. Cities such as Detroit, Mich. in the US and developing nations overseas with extensive poverty may seek economic and financial growth, stimulation and/or revitalization. For cities in developing countries, most foreign loans are made in “hard”/foreign currencies while their earnings are in their “soft”/local currencies that may fluctuate in value widely against the currencies of developed nations. While currency conversion is not a major factor within developed nations, for developing economies in and outside the US, conventional loans are unlikely to reverse the negative cycle and repayment is still dependent solely on the borrower's ability to repay. The disclosed risk-management loan structure for a system of finance is designed to address the currency value fluctuations. The inventive concept is designed to curtail loan defaults by keeping the repayment and the loan in hard (or similar) currencies so as not to depend on the borrower's ability to repay through the value of a softer currency from a developing nation. This makes it far less burdensome on the borrower, increases the assurance to the lender of the loan being repaid while simultaneously stimulating economic growth.

With the disclosed Zero-Coupon Loan, the lender provides the borrower with a long-term, relatively low interest rate loan and a percentage of the loan proceeds (for example 10% to 30%) is set aside in the same currency as the loan (or another hard or similar currency) and invested at a relatively higher rate of return than the interest rate of the received loan so that the loan can be repaid at or prior to maturity. This simultaneously reduces the risk of default, provides additional security to the lender, reduces or eliminates the burden of debt repayment by the borrower, and stimulates economic growth. The exact percentage that is escrowed for investment and how the funds are invested and managed should be mutually agreed to by both parties in a cooperative effort with the goal of reaching zero (0) amount due at or before maturity.

For example, the United States agrees to lend Ethiopia US$500 MILLION for infrastructure development at 2% for 50 years. US$100 MILLION (20% of the loan proceeds) is escrowed and invested at a 15% rate of return. The US$500 MILLION loan amortized over 50 years is US$791.4 MILLION and the US$100 MILLION investment will be over US$108.4 BILLION. In addition to the potential earnings of over US$107 BILLION from the invested escrowed funds, the loan could be paid off in entirety by the eleventh (11^{th}) year solely from interest earnings. Therefore, the loan can be repaid with the funds that are set aside and zero is due prior to maturity.

### BRIEF DESCRIPTION OF THE DRAWINGS

FIG. 1 illustrates a method of protecting value in two economic systems.

FIG. 2 illustrates a computer system used in the method of protecting value in two economic systems.

FIG. 3 illustrates how a standard loan becomes a method of protecting value in two economic systems.

FIG. 4 illustrates representative digital currencies.

FIG. 5 illustrates a blockchain system for the digital currencies.

FIG. 6A-6B illustrates a representative method of protecting value in two economic systems.

### DETAILED DESCRIPTION OF THE INVENTION

The following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

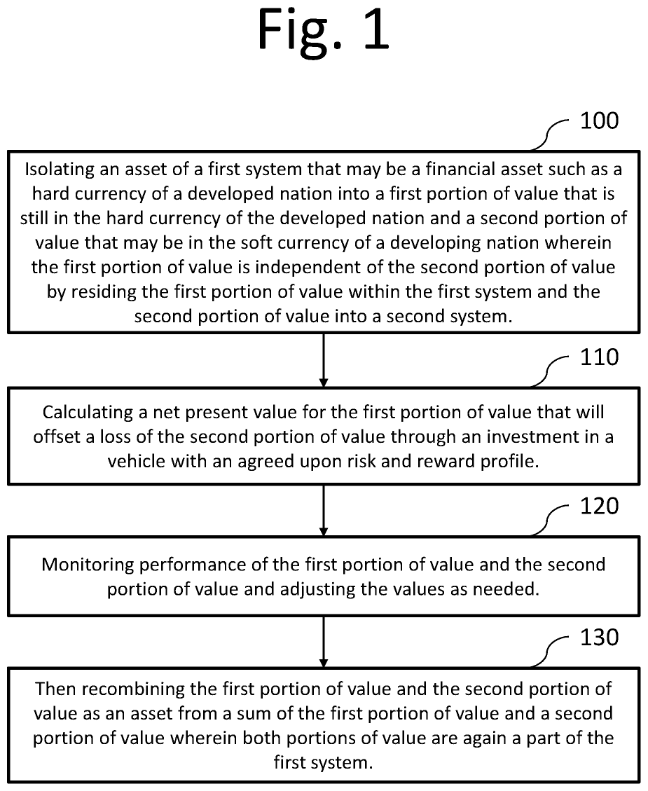

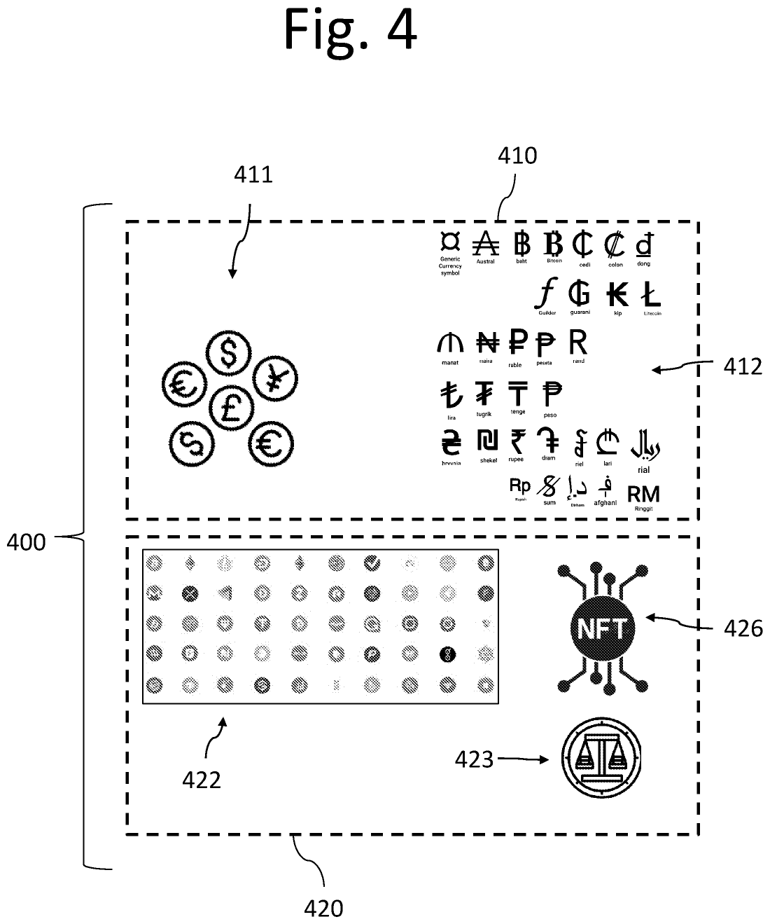

Referring to the Figures, FIG. 1 illustrates the inventive concept is a system and method 10 of protecting value that involves isolating an asset of a first system 40 that may be, as illustrated in FIG. 4, a financial asset 400 such as a national currency 410 hard currency of a developed nation 411 into a first portion of value that is still in the hard currency of the developed nation 411 and a second portion of value that may be in the soft currency of a developing nation 412 wherein the first portion of value is independent of the second portion of value by residing the first portion of value within the first system and the second portion of value into a second system illustrated in step 100. The difference between 411 and 412 may change as a country's political and economic systems change and reflects comparative stability and acceptability of the value represented by the currency. Calculating a net present value for the first portion of value that will offset a loss of the second portion of value through an investment in a vehicle with an agreed upon risk and reward profile of step 110. Monitoring performance of the first portion of value and the second portion of value and adjusting the values as needed in step 120. Then recombining the first portion of value and the second portion of value as an asset from a sum of the first portion of value and a second portion of value wherein both portions of value are again a part of the first system illustrated in step 130.

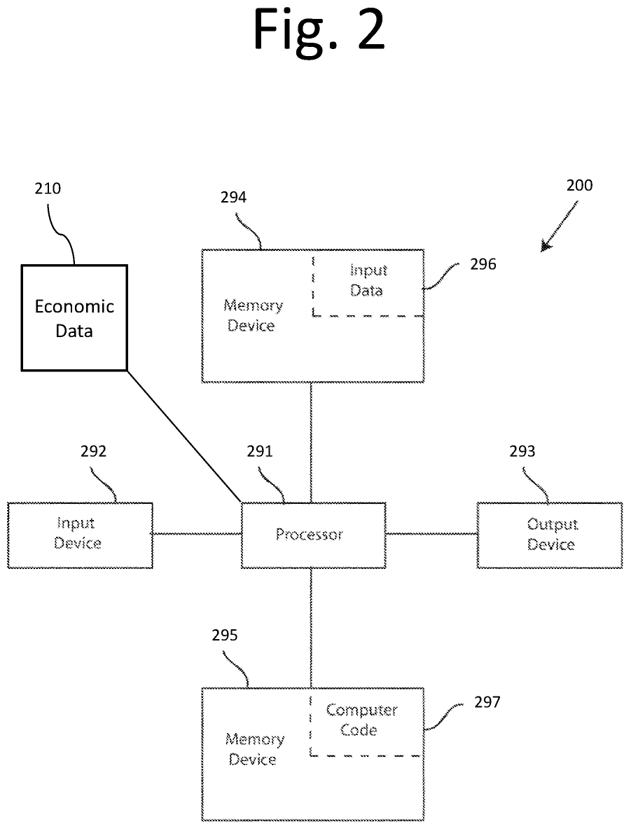

FIG. 2 illustrates in accordance with embodiments of the invention taught herein of an at least one computer system 200 associated with either or both the first system and the second system as would be considered economic data 210 and may generally comprise a processor 291, an input device 292 coupled to the processor 291, an output device 293 coupled to the processor 291, and memory devices 294 and 295 each coupled to the processor 291. Economic data 210 could be read and analyzed by the processor 291. The input device 292, output device 293, and memory devices 294, 295 may each be coupled to the processor 291 via a bus, the memory device holding algorithms to address the economic data. Processor 291 may perform computations and control the functions of the computer system 200, including executing instructions included in the computer code 297 for the tools and programs capable of implementing a method for obtaining records about economic data 210, wherein the instructions of the computer code 297 may be executed by the processor 291 via the memory device 294, 295. The computer code 297 may include software or program instructions that may implement one or more algorithms for implementing the methods for obtaining and analyzing economic data 210. The processor 291 executes computer code 297. Processor 291 may include a single processing unit, or may be distributed across one or more processing units in one or more locations (e.g., on a client server).

The memory device 294 may include input data 296. The input data 296 includes any inputs required by the computer code 297. The output device 293 displays output from the computer code 297. Either or both memory devices 294 and 295 may be used as a computer usable storage medium (or program storage device) having a computer readable program embodied therein and/or having other data stored therein, wherein the computer readable program comprises the computer code 297. Generally, a computer program product (or, alternatively, an article of manufacture) of the computer system 200 may comprise the computer usable storage medium (or the program storage device).

The memory devices 294, 295 include any known computer readable storage medium, including those described in detail below. In one embodiment, cache memory elements of memory devices 294, 295 may provide temporary storage of at least some program code (e.g., computer code 297) in order to reduce the number of times code must be retrieved from bulk storage while instructions of the computer code 297 are executed. Moreover, similar to processor 291, memory devices 294, 295 may reside at a single physical location, including one or more types of data storage, or be distributed across a plurality of physical systems in various forms. Further, memory devices 294, 295 can include data distributed across, for example, a local area network (LAN) or a wide area network (WAN). Further, memory devices 294, 295 may include an operating system (not shown) and may include other systems not shown in FIG. 2.

In some embodiments, the computer system 200 may further be coupled to an Input/output (I/O) interface and a computer data storage unit. An I/O interface may include any system for exchanging information to or from an input device 292 or output device 293. The output device 293 may be, inter alia, a printer, a plotter, a display device (such as a computer screen), a magnetic tape, a removable hard disk, a floppy disk, etc. The memory devices 294 and 295 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 200, and may include any type of transmission link, including electrical, optical, wireless, etc.

FIG. 2 further illustrates the inventive concept uses a system of protecting value in two economic systems that has at least one computer system 200 adapted to divide an asset of a first system into a first portion of value and a second portion of value wherein the first portion of value is independent of the second portion of value by residing the first portion of value within the first system and the second portion of value into a second system. At least one memory device 294, 295 is designed to calculate from an algorithm the net present value for the first portion of value that will offset a loss of the second portion of value. The at least one computer system 200 is designed to monitor the performance of the first portion of value and the second portion of value. The at least one computer system 200 is designed to recombine the asset as a sum of the first portion of value and a second portion of value wherein both portions of value are a part of the first system.

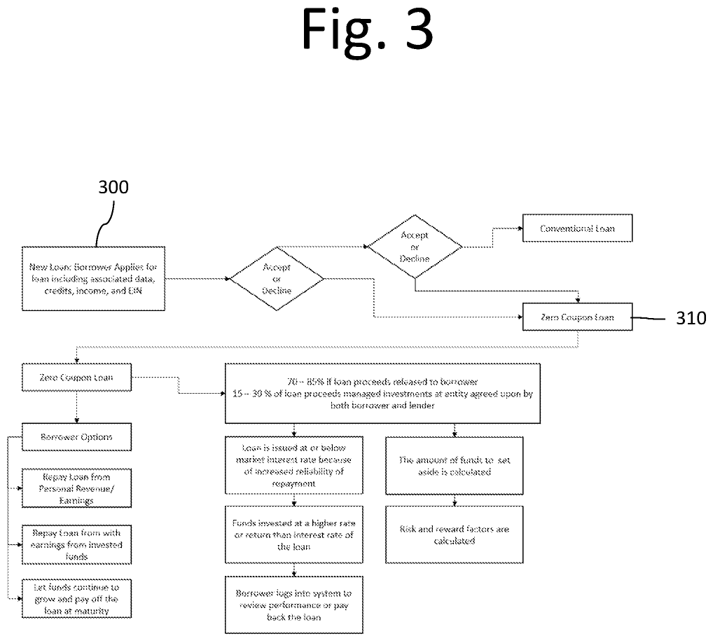

FIG. 3 illustrates a second flow if the inventive concept wherein the loan element 300 becomes a zero-coupon loan 310 set in two separate economic systems.

Exemplified results include:
Investing Calculator
How much will an investment be worth in the future?
Investment $100,000,000
Annual Deposits $0.00
Rate of Return 15% (annually)
Years 50
[After 50 years, your investment will have grown to $108,365,744,158. In year 11, the earnings will exceed the outstanding loan balance.]

Investment Growth Over Time
Year Value Start $100,000,000 1 $115,000,000
2 $132,250,000
3 $152,087,500
4 $174,900,625
5 $201,135,719
6 $231,306,077
7 $266,001,988
8 $305,902,286
9 $351,787,629
10 $404,555,774
11 $465,239,140
12 $535,025,011
13 $615,278,762
14 $707,570,576
15 $813,706,163
16 $935,762,087
17 $1,076,126,400
18 $1,237,545,361
19 $1,423,177,165
20 $1,636,653,739
21 $1,882,151,800
22 $2,164,474,570
23 $2,489,145,756
24 $2,862,517,619
25 $3,291,895,262
26 $3,785,679,551
27 $4,353,531,484
28 $5,006,561,207
29 $5,757,545,388
30 $6,621,177,196
31 $7,614,353,775
32 $8,756,506,841
33 $10,069,982,867
34 $11,580,480,298
35 $13,317,552,342
36 $15,315,185,194
37 $17,612,462,973
38 $20,254,332,419
39 $23,292,482,281
40 $26,786,354,623
41 $30,804,307,817
42 $35,424,953,990
43 $40,738,697,088
44 $46,849,501,651
45 $53,876,926,899
46 $61,958,465,934
47 $71,252,235,824
48 $81,940,071,197
49 $94,231,081,877
50 $108,365,744,158
Source—www.worksheets.org/invest and US Securities Exchange Commission www.Investor.gov
   Amortization Calculator
   Loan Amount $500,000,000
   Loan Term 50 years
   Interest Rate (APR) 2%
   [The total loan and interest paid over 50 years is $791,371,877. By year 11 the entire loan can be repaid from the interest earned from the invested funds]
   Annual Amortization Schedule
Beginning Balance Interest Principal Ending Balance
1 $500,000,000.00 $9,946,283.95 $5,381,153.85 $494,113,846.19
2 $494,118,846.19 $9,827,576.64 $5,999,861.16 $488,118,985.09
3 $488,118,985.09 $9,706,473.30 $6,120,964.50 $481,998,020.65
4 $481,998,020.65 $9,532,925.57 $6,244,512.23 $475,753,508.49
5 $475,753,508.49 $9,456,884.13 $6,370,553.67 $469,382,954.88
6 $469,382,954.88 $9,328,298.61 $6,499,139.19 $462,883,815.74
7 $462,883,815.74 $9,197,117.67 $6,630,320.13 $456,253,495.67
8 $456,253,495.67 $9,063,288.93 $6,764,148.87 $449,489,346.87
9 $449,489,346.87 $8,926,753.95 $6,900,678.85 $442,588,668.07
10 $442,588.668.07 $8,737,473.19 $7,039,964.61 $435,548,703.52
11 $435,548.703.52 $8,645,376.04 $7,182.061.76 $428,366,641.83
12 $428,366,641.83 $3,500,410.77 $7,327,027.03 $421,039,614.84
13 $421,039,614.84 $8,352.519.43 $7,474,918.37 $413,564,696.54
14 $413,564,696.54 $8,201.643.02 $7,625,794.73 $405,938,901.82
15 $405,938.901.82 $8,047,721.29 $7,779,716.51 $398,159,185.35
16 $398,159.185.35 $7,890,692.70 $57,936.745.10 $390,222,440.32
17 $390,222,440.32 $7,730,494.63 $8,096,943.17 $382,125,497.21
18 $382,125,497.21 $7,567,063.04 $8,260,374.76 $373,865,122.51
19 $373,865,122.51 $7,400.332.70 $8,427,105.10 $365,438,017.48
20 $365,438,017.48 $7,230,237.01 $8,597,200.79 $356,840,816.75
21 $356,840,816.75 $7,056,708.06 $8,770,729.74 $348,070,087.07
22 $348,070,087.07 $6,879,676.54 $8,947,761.26 $339,122,325.87
23 $339,122,325.87 $6,699,071.76 $9,128,366.04 $329,993,959.87
24 $329,993,959.87 $6,514,821.55 $9,312,616.25 $320,681,343.68
25 $320,681,343.68 $6,326,852.39 $9,500,585.41 $311,180,758.33
26 $311,180,758.33 $6,135,089.22 $9,692,348.58 $301,488,409.79
27 $301,488,409.79 $5,939,455.39 $9,887,982.41 $291,600,427.45
28 $291,600,427.45 $5,739,872.85 $10,087,564.95 $281,512,862.54
29 $281,512,862.54 $5,536,261.83 $10,291,175.97 $271,221,686.64
30 $271,221,686.64 $5,328,541.07 $10,498,896.73 $260,722,789.99
31 $260,722,78999 $5,116,627.63 $10,710,810.17 $250,011,979.87
32 $250,011,979.87 $4,900,436.82 $10,927,000.98 $239,084,978.95
33 $239,084,978.95 $4,679,882.35 $11,147,555.45 $227,937,423.56
34 $227,937,423.56 $4,454,876.14 $11,372,561.66 $216,564,861.94
35 $216,564,861.94 $4,225,328.30 $11,602,109.50 $204,962,752.50
36 $204,962,752.50 $3,991,147.18 $11,836,290.62 $193,126,461.95
37 $193,126,461.95 $3,752,239.28 $12,075,198.52 $181,051,263.50
38 $181,051,263.50 $3,508,509.20 $12,318,928.60 $168,732,334.95
39 $168,732,334.95 $3,259,859.56 $12,567,578.24 $156,164,756.77
40 $156,164,756.77 $3,006,191.09 $12,821,246.71 $143,343,510.12
41 $143,343,510.12 $2,747,402.48 $13,080,035.32 $130,263,474.87
42 $130,263,474.87 $2,483,390.41 $13,344,047.39 $116,919,427.53
43 $116,919,427.53 $2,214,049.39 $13,613,388.41 $103,306,039.20
44 $103,306,039.20 $1,939,271.94 $13,888,165.86 $89,417,873.39
45 $89,417,873.39 $1,658,948.26 $14,168,489.54 $75,249,383.90
46 $75,249,383.90 $1,372,966.43 $14,454,471.37 $60,794,912.59
47 $60,794,912.59 $1,081,212.22 $14,746,225.58 $46,048,687.08
48 $46,048,687.08 $783,569.18 $15,043,868.62 $31,004,818.51
49 $31,004,818.51 $479,918.39 $15,347,519.41 $15,657,299.15
50 $15,657,299.15 $170,138.59 $15,657,299.21 $0.00

In addition to the $107.6 Billion profit, the proceeds from the invested funds are enough to repay the loan in entirety by the 11^{th} year (loan amount owed $435 million and earnings from investment $465 million)] *Source—http://www.calculator.net/amortization-calculator *-APR—means Annual Percentage Rate *$—means United States Dollar.

FIG. 4 illustrates that in one representative embodiment of the system of protecting value in two economic systems, the asset includes at least one or more of a digital currency 420. In one embodiment, the at least one or more digital currencies is a stable coin 423, the stable coin's value aligned to at least one national currency 410. One embodiment is a traditional digital currency 422 independent of a national currency 410. In one embodiment, the at least one the national currencies is the US dollar 413. In one embodiment, the asset 400 includes at least one or more of a non-fungible token 426.

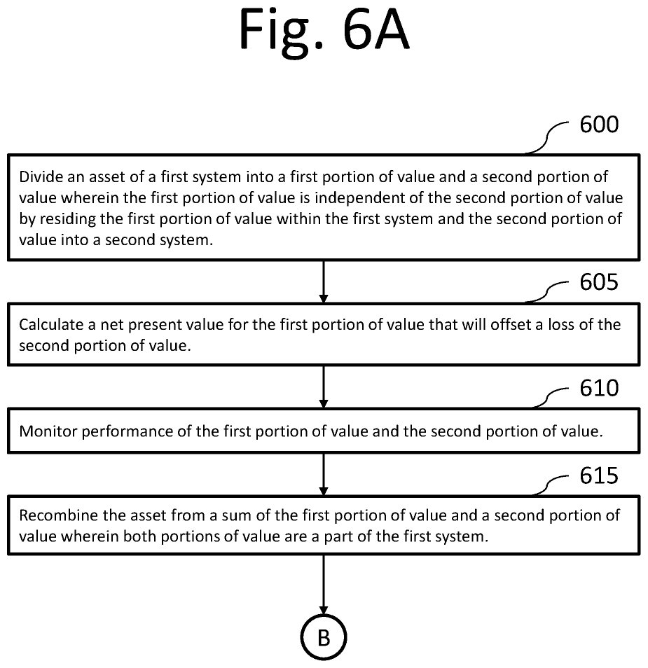

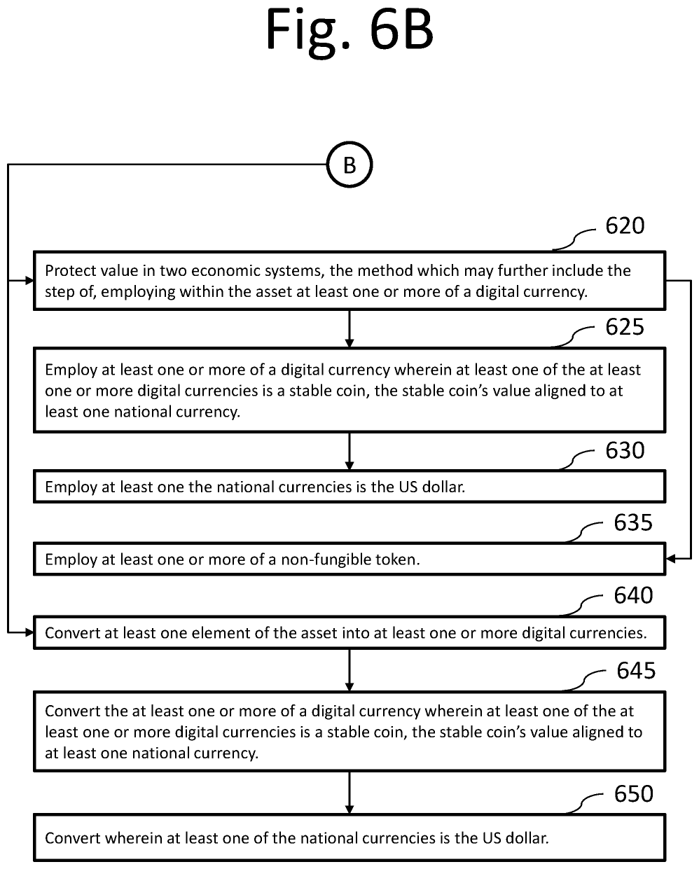

FIG. 6A-6B illustrates a representative method of protecting value in two economic systems, the method including the step of 600, dividing an asset of a first system into a first portion of value and a second portion of value wherein the first portion of value is independent of the second portion of value by residing the first portion of value within the first system and the second portion of value into a second system. The method further includes the step of 605, calculating a net present value for the first portion of value that will offset a loss of the second portion of value. The method further includes the step of 610, monitoring performance of the first portion of value and the second portion of value. The method further includes the step of 615, recombining the asset from a sum of the first portion of value and a second portion of value wherein both portions of value are a part of the first system.

FIG. 6A-6B illustrates a representative method of protecting value in two economic systems, the method which may further include the step of 620, employing within the asset at least one or more of a digital currency.

FIG. 6A-6B illustrates a representative method of protecting value in two economic systems, the method which may further include the step of 625, employing at least one or more of a digital currency wherein at least one of the at least one or more digital currencies is a stable coin, the stable coin's value aligned to at least one national currency.

FIG. 6A-6B illustrates a representative method of protecting value in two economic systems, the method which may further include the step of 630, employing at least one the national currencies is the US dollar.

FIG. 6A-6B illustrates a representative method of protecting value in two economic systems, the method which may further include the step of 635, employing at least one or more of a non-fungible token.

FIG. 6A-6B illustrates a representative method of protecting value in two economic systems, the method which may further include the step of 640, converting at least one element of the asset into at least one or more digital currencies.

FIG. 6A-6B illustrates a representative method of protecting value in two economic systems, the method which may further include the step of 645, converting the at least one or more of a digital currency wherein at least one of the at least one or more digital currencies is a stable coin, the stable coin's value aligned to at least one national currency.

FIG. 6A-6B illustrates a representative method of protecting value in two economic systems, the method which may further include the step of 650, wherein the method further includes that at least one of the national currencies is the US dollar.

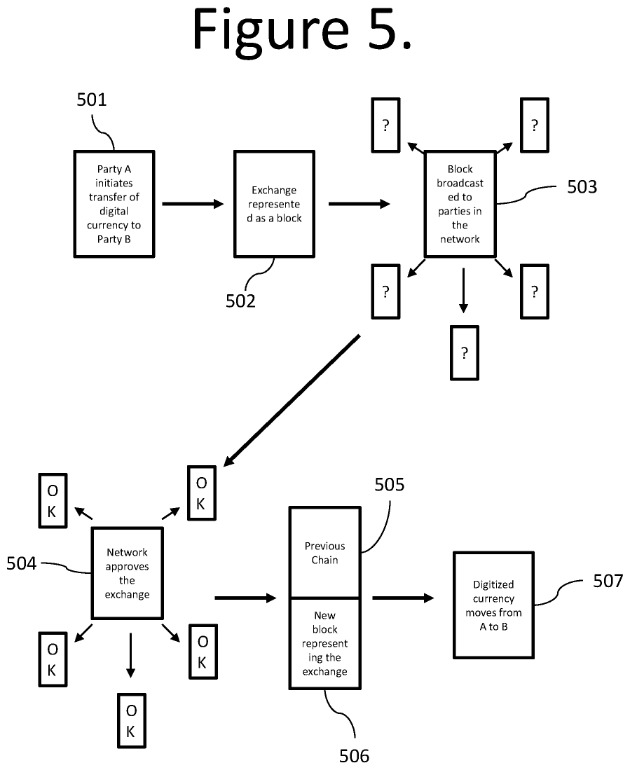

Now referring to FIG. 5, a process diagram, a blockchain update according to some implementations is shown. In step 501, party A initiates the transfer of a digital artwork to party B. In some embodiments, Party A may prove that he has possession of the digital artwork by signing the transaction with a private key that may be verified with a public key in the previous transaction of the digital artwork. In step 502, the exchange initiated in step 501 is represented as a block. In some embodiments, the transaction may be compared with transaction records in the longest chain in the distributed system to verify party A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-time, or proof-of-space, may be used in the system. In some embodiments, a block may represent one or more transactions between different parties that are broadcasted to the nodes. In step 503, the block is broadcasted to parties in the network. In step 504, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the digital artwork he or she seeks to transfer). In some embodiments, a block may be approved with consensus of the nodes in the network. After a block is approved, the new block 506 representing the exchange is added to the existing chain 505 comprising blocks that chronologically precede the new block 506. The new block 506 may contain the transaction or transactions and a hash of one or more blocks in the existing chain 505. In some embodiments, each node may then update their copy of the blockchain with the new block and continue to work on extending the chain with additional transactions. In step 507, when the chain is updated with the new block, the digital artwork is moved from party A to party B.

The following patents are incorporated by reference in their entireties: U.S. Pat. Nos. 20030191702A1, 20080262956A1, and 8583545B1.

While the inventive concept has been described above in terms of specific embodiments, it is to be understood that the inventive concept is not limited to these disclosed embodiments. Upon reading the teachings of this disclosure many modifications and other embodiments of the inventive concept will come to mind of those skilled in the art to which this inventive concept pertains, and which are intended to be and are covered by both this disclosure and the appended claims. It is indeed intended that the scope of the inventive concept should be determined by proper interpretation and construction of the appended claims and their legal equivalents, as understood by those of skill in the art relying upon the disclosure in this specification and the attached drawings.

1. A system of protecting value in two economic systems comprising:
at least one computer system adapted to divide an asset of a first system into a first portion of value and a second portion of value wherein the first portion of value is independent of the second portion of value by residing the first portion of value within the first system and the second portion of value into a second system;
at least one memory device adapted to calculate from an algorithm the net present value for the first portion of value that will offset a loss of the second portion of value;
the at least one computer system adapted to monitor the performance of the first portion of value and the second portion of value; and
the at least one computer system adapted to recombine the asset as a sum of the first portion of value and a second portion of value wherein both portions of value are a part of the first system.

2. The system of protecting value in two economic systems of claim 1 wherein the asset includes at least one or more of a digital currency.

3. The system of protecting value in two economic systems of claim 2 wherein the asset includes at least one or more of a digital currency wherein at least one of the at least one or more digital currencies is a stable coin, the stable coin's value aligned to at least one national currency.

4. The system of protecting value in two economic systems of claim 3 wherein at least one of the at least one the national currencies is the US dollar.

5. The system of protecting value in two economic systems of claim 1 wherein the asset includes at least one or more of a non-fungible token.

6. A method of protecting value in two economic systems, the method comprising:
dividing an asset of a first system into a first portion of value and a second portion of value wherein the first portion of value is independent of the second portion of value by residing the first portion of value within the first system and the second portion of value into a second system;
calculating a net present value for the first portion of value that will offset a loss of the second portion of value;
monitoring performance of the first portion of value and the second portion of value; and
recombining the asset from a sum of the first portion of value and a second portion of value wherein both portions of value are a part of the first system.

7. The method of protecting value in two economic systems of claim 6 wherein the method further includes employing within the asset at least one or more of a digital currency.

8. The method of protecting value in two economic systems of claim 7 wherein the metho further includes employing at least one or more of a digital currency wherein at least one of the at least one or more digital currencies is a stable coin, the stable coin's value aligned to at least one national currency.

9. The method of protecting value in two economic systems of claim 8 wherein the metho further includes employing at least one the national currencies is the US dollar.

10. The method of protecting value in two economic systems of claim 6 wherein the asset includes employing at least one or more of a non-fungible token.

11. The method of protecting value in two economic systems of claim 6 wherein the metho further includes converting at least one element of the asset into at least one or more digital currencies.

12. The method of protecting value in two economic systems of claim 11 wherein the method further includes converting the at least one or more of a digital currency wherein at least one of the at least one or more digital currencies is a stable coin, the stable coin's value aligned to at least one national currency.

13. The method of protecting value in two economic systems of claim 12 wherein the method further includes that at least one of the national currencies is the US dollar.
